(19) United States
(12) Patent Application Publication
(10) Pub. No.: US 2018/0204126 A1
(43) Pub. Date: Jul. 19, 2018

(54) METHOD AND SYSTEM FOR ASSISTING USERS IN AN AUTOMATED DECISION-MAKING ENVIRONMENT

(71) Applicant: Xerox Corporation, Norwalk, CT (US)

(72) Inventor: Matthias Gallé, Eybens (FR)

(73) Assignee: Xerox Corporation, Norwalk, CT (US)

(21) Appl. No.: 15/407,782

(22) Filed: Jan. 17, 2017

(51) Int. Cl. G06N 5/04; G06N 7/00

(52) U.S. Cl. CPC G06N 5/045; G06N 7/00

(57) ABSTRACT

A system and method guide the modification of an input feature vector to an automatic classifier model to cause the classifier to give a desired class without modifying the classifier. A user defines costs for independently modifying feature values for at least some of the features in an initial feature vector that the classifier model has given an undesired class. Subspaces are identified in a feature space in which the classifier model classifies feature vectors in the desired class. With a cost function which takes into account the user-defined costs, a modified feature vector is identified in one of the identified subspaces which optimizes the cost function. The modified feature vector or information based thereon is output.

### BACKGROUND

The exemplary embodiment relates to automated classification based on a set of features and finds particular application in connection with a system and method for modifying the set of features to change the output class, without modifying the classifier.

Increasingly, processes governing human lives are based, at least in part, on an automatic decision step. A feature vector is generated which encodes attributes of a given person and a binary classifier is used to output a decision which influences the final outcome. In some cases, these decisions do not have significant impact on the person, such as a decision on movies or books to recommend to a person. However, consequences can be more severe in some cases. For example, decision algorithms are used in determining whether to provide a mortgage to a person, based on age, financial details, etc., whether grant bail to an accused person, based on factors such as the risk of flight, the severity of the alleged crime, the likelihood the person could pose a danger to others, and so forth, or to determine a length of a sentence. In some cases, these systems are beneficial. For example, they can reduce the number of those incarcerated based on their inability to post bail. However, in other cases, they may have more severe consequences. In some cases, the decision is computed with a proprietary model and the way in which risk factors are taken into account is not clearly understood. For example, a longer sentence could be given to a person because a similar population is predicted to have a greater risk of reoffending. This puts people into situations where they cannot know why that decision was reached, nor can they modify the outcome.

Current solutions like open-sourcing the decision model, or adding justification of the decisions can provide a level of transparency, but do not change the decision.

Given a binary classifier trained to classify a feature vector as being in a given class or not, it is desirable to provide a mechanism by which the feature vector can be modified, in a small way, in order to obtain a modified feature vector that is classified by the classifier as being in the opposite class. This can be achieved by minimizing a distance between the original feature vector and the modified feature vector. Methods for solving this have been proposed, for different classifiers, with the aim of active learning or adversarial learning. One approach considers the case of the Naïve Bayes classifier, and proposes a learning strategy that takes into account the presence of an adversary using tools from game theory. See Dalvi, et al., “Adversarial classification,” Proc. 10th ACM SIGKDD Int'l Conf. on Knowledge discovery and data mining, pp. 99-108, 2004. It solves the problem for linear models, multi-layer perceptrons and for various kernels of SVM.

Various projected gradient descent methods have also been proposed to obtain realistic samples (which are in a dense space with respect to the training data). See. Biggio, et al., “Evasion attacks against machine learning at test time,” Joint European Conf. on Machine Learning and Knowledge Discovery in Databases, pp. 387-402, 2013 (hereinafter, Biggio 2013). In Kantchelian, et al., “Evasion and Hardening of Tree Ensemble Classifiers,” Intl Conf. on Machine Learning (ICML), 2016, the problem of evading a decision tree is addressed. Two solutions are proposed: an exact one, relying on integer linear programming techniques, and a heuristics-based one using iterative coordinate descent. Both solutions are given for the case where the distance to be minimized is a norm (lₚ). This precludes cases where the features are meaningful attributes (instead of, say, pixels), some of which cannot be changed, and where the cost may vary greatly.

A system and method are provided which enable a user to influence the decision process by defining cost functions for individual features which reflect the user's circumstances and preferences.

### BRIEF DESCRIPTION

In accordance with one aspect of the exemplary embodiment, a method for guiding users in an automated decision-making environment includes receiving an initial feature vector which is classified with a classifier model, the classification being a second of a plurality of classes. Provision is made for a user to define costs for independently modifying feature values for at least some features in the initial feature vector. Subspaces are identified in a feature space in which the classifier model classifies an input feature vector in a first of the set of classes. With a cost function which takes into account the user-defined costs, a modified feature vector is identified in one of the identified subspaces which optimizes the cost function. The modified feature vector or information based thereon is output.

At least one of the steps of the method may be performed with a processor.

In accordance with another aspect of the exemplary embodiment, a system for guiding users in an automated decision-making environment includes a classifier component which classifies a feature vector with a classifier model and outputs a classification for an input feature vector. A graphical user interface generator provides for a user to define costs for modifying feature values for at least some of the features in a feature vector for which the classification is a second of a set of classes. A mapping component identifies subspaces in a feature space in which the classifier model classifies an input feature vector in a second of the set of classes. A modification component identifies a modified feature vector in one of the identified subspaces which optimizes a cost function with a subset of the user defined costs. An output component outputs the modified feature vector or information based thereon. A processor implements the classifier component, graphical user interface generator, mapping component, modification component, and output component.

In accordance with another aspect of the exemplary embodiment, a method for guiding users in an automated decision-making environment includes identifying leaves of decision trees of a random forest classifier model which are associated with a first of a plurality of classes. A graph is generated in which nodes represent the identified leaves. The graph generation includes connecting pairs of nodes, which represent leaves that are not inconsistent, with edges. Cliques in the graph of size at least

$$⌊ \frac{k}{2} ⌋ + 1$$

nodes are identified, where k is the number of decision trees. Each clique corresponds to a subspace in which a feature vector is classified by the classifier model in a first of a plurality of classes. Provision is made for a user to define costs for modifying feature values of at least some of the features in an initial feature vector which is classified by the classifier model in a second of the plurality of classes. With a cost function which takes into account the user-defined costs, identifying a modified feature vector in one of the identified subspaces which optimizes the cost function. The modified feature vector or information based thereon is output.

At least one of the identifying leaves, identifying cliques and identifying a modified feature vector may be performed with a processor.

### BRIEF DESCRIPTION OF THE DRAWINGS

FIG. 1 is a functional block diagram of a system for guiding a user to modify an automatic decision in accordance with one aspect of the exemplary embodiment;

FIG. 2 is a flowchart illustrating a method to modify an automatic decision in accordance with one aspect of the exemplary embodiment;

FIG. 3 illustrates a graphical user interface;

FIG. 4 illustrates an example random forest classifier model; and

FIG. 5 illustrates a graph generated from the random forest of FIG. 4.

### DETAILED DESCRIPTION

A system and method are now described which assume the existence of a binary classifier which has been trained to output a decision based on an input vector of attributes. A user for whom a decision is being made is provided with alternatives which would make the decision algorithm decide differently. The method includes enumerating subspaces within the multidimensional space defined by the ranges of possible feature values where the classifier provides the desired output. As an example, the specific case of classifiers based on decision forests (ensemble methods based on decision trees) is considered by mapping the problem to an iterative version of enumerating k-cliques.

The system and method provide the user with a set of steps to perform in order to achieve the desired outcome. The system and method do not require disclosing details about the model which makes the decision. Rather, the user is asked to weight, with a non-negative value, the relative cost of changing the features. The weights can vary depending on the feature, and may be linear, infinite (e.g., for changing height, or getting younger), quadratic (e.g., losing weight) or any other function, that is not necessarily differentiable or symmetric. Based on the user inputs, the system recommends an alternative set of feature values that optimizes (e.g., minimizes) the modification cost but ensures that the output decision would change. The system may be in the form of a tool which can be used either independently by the end-user, or it could be part of a solution provided to an intermediate human agent whose interest is to provide a positive solution but without raising red flags in his institutional system, for example, an agent processing credit requests.

By enumerating all subspaces where the classifier would provide the desired decision, and returning those that are close enough to the original feature vector, with respect to the cost function, the method can be very flexible and user-specific.

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

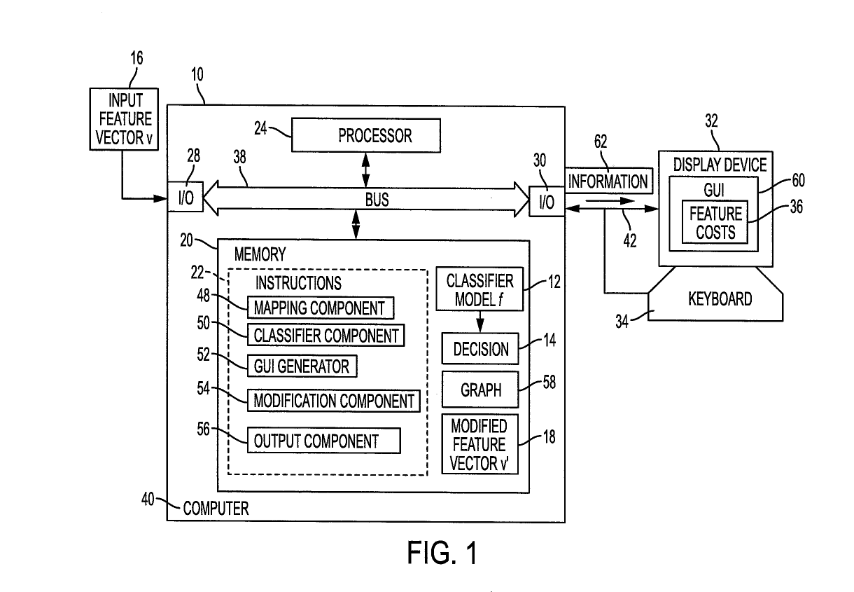

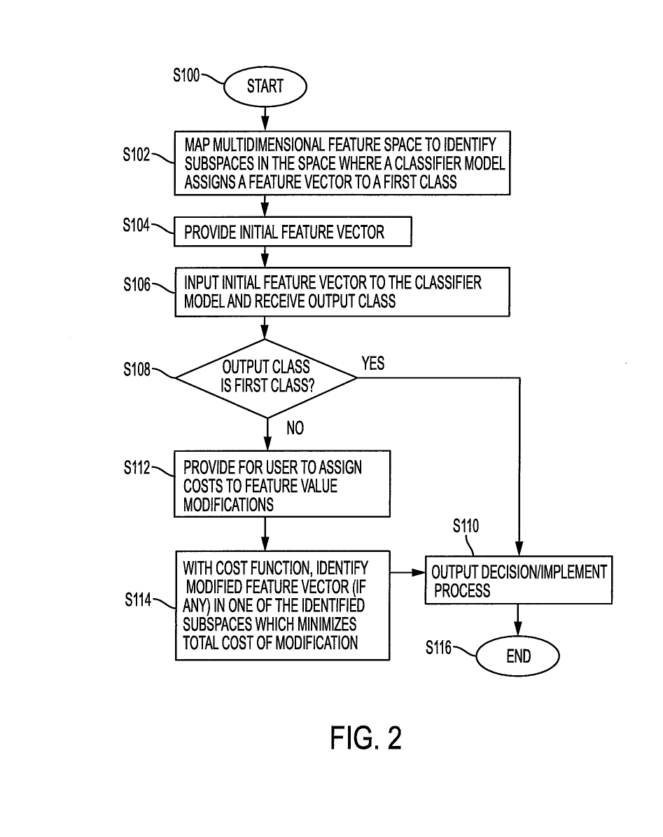

With reference to FIG. 1, a system 10 for assisting a user to modify a decision, given a classifier model 12, is illustrated. The classifier model 12 may include one or a set of classifiers for generating a decision 14, given an input feature vector, such as an initial or modified feature vector 16, 18 comprising values for each of a set of features. The computer-implemented system 10 includes memory 20 which stores instructions 22 for performing the method illustrated in FIG. 2 and a processor 24, in communication with the memory, for executing the instructions. The system 10 also includes one or more input/output (I/O) devices, such as a network interface 28 which receives the initial feature vector 16 and an interface 30 which communicates with one or more of a display device 32, for displaying information to users, speakers, and a user input device 34, such as a keyboard or touch or writable screen, and/or a cursor control device, such as mouse, trackball, or the like, for inputting text and for communicating user input information and command selections to the processor device 24, such as costs (weights) 36 for modifying features for generating a modified feature vector 18. The various hardware components 20, 24, 28, 30 of the system 10 may all be connected by a data/control bus 38. While the display device 32 and user input device 34 are illustrated as being directly linked to computer 40, which hosts the system, it is to be appreciated that they may form a part of a separate client device, having its own processor and memory, which is wired or wirelessly linked to the computer 40.

The computer system 10 may include one or more computing devices 40, such as a PC, such as a desktop, a laptop, or palmtop computer, portable digital assistant (PDA), server computer, cellular telephone, tablet computer, pager, combination thereof, or other computing device capable of executing instructions for performing the exemplary method.

The memory 20 may represent any type of non-transitory computer readable medium such as random access memory (RAM), read only memory (ROM), magnetic disk or tape, optical disk, flash memory, or holographic memory. In one embodiment, the memory 20 comprises a combination of random access memory and read only memory. In some embodiments, the processor 24 and memory 20 may be combined in a single chip. Memory 20 stores instructions for performing the exemplary method as well as the processed data 14, 18, etc. The classifier model 12 may be resident on the computing device 40 or accessed on a remote computing device, such that the parameters of the model are not known to the system.

The interface 28, 30 allows the computer to communicate with other devices via a wired or wireless link 42, e.g., a computer network, such as a local area network (LAN) or wide area network (WAN), or the internet, and may comprise a modulator/demodulator (MODEM) a router, a cable, and/or Ethernet port.

The digital processor device 24 can be variously embodied, such as by a single-core processor, a dual-core processor (or more generally by a multiple-core processor), a digital processor and cooperating math coprocessor, a digital controller, or the like. The digital processor 24, in addition to executing instructions 22 may also control the operation of the computer 40.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The illustrated instructions include a mapping component 48, a classifier component 50, a Graphical User Interface (GUI) generator 52, a modification component 54, and an output component 56. Briefly, the mapping component 48 identifies one or more subspaces in the feature space where the feature vectors are classified by the classifier in the desired (first) class. In the case of decision trees as the classifier model, this may include generating a graph 58 which connects leaves of the trees representing the desired class by edges whenever the associated leaves are not mutually exclusive. Once the mapping has been performed, the mapping component is no longer needed and can be omitted from the system. The classifier component 50 uses the classifier model 12 to generate a classification for the feature vector 16. The GUI generator 52 generates a GUI 60 for display to the user on the display device 32 which enables the user to assign costs 36 to modifications to the feature values when the classification is a second (undesired) class. The modification component 54 identifies a modified feature vector 18, based on the assigned costs, which optimizes (e.g., minimizes, when costs are positive values) the cost of changing the initial feature vector so that it is in a subspace identified by the mapping component where the modified feature vector is classified in the first, desired class. The output component outputs information 62, such as the modified feature vector 18, the decision 14, the result of a process performed based thereon, information based thereon, or a combination thereof.

The exemplary decision system 10 can provide help to the user, in the form of concrete actions that the user can take in order to obtain a desired output. The user is able to specify a user-specific cost function, which can be of any form, allowing comparison between different changes of feature values. By enumerating all (or at least a significant quantity) of the subspaces where the classifier would provide the desired decision, a suitable modification to the input vector can be identified. In the case of forests of decision trees, enumerating these subspaces can be mapped to the problem of enumerating k-cliques, for which an efficient implementation exists.

FIG. 2 illustrates a method for assisting a user to modify a decision by an automated classifier model, which can be performed with the system of FIG. 1. The method begins at S100.

At S102, multidimensional feature space corresponding to the possible values of a set of features is mapped, by the mapping component 50, to identify regions in the space where the classifier model 12 assigns a feature vector to a desired (first) class. This may include enumerating all (or at least some) subspaces where the classifier outputs a desired decision. This step may alternatively be performed later in the process, for example, before or during step S114.

At S104 an initial feature vector 16 is provided, e.g., input by a user.

At S106, the initial feature vector 16 is input to the trained classifier model 12, which outputs an initial decision 14, such as a class from a plurality of classes. In the exemplary embodiment, there are only two classes, although it is contemplated that the method could be extended to more than two classes.

If at S108, the decision is the first class of the plurality of classes, which is the outcome desired, the method proceeds to S110, where the decision is output and/or used to implement a process, such as confirming a credit application, or the like. Otherwise, the method proceeds to S112.

At S112 a mechanism is provided for the user to assign costs to feature modifications, e.g., through a graphical user interface 60 generated by the GUI generator 52 and displayed to the user on the display device 32. The user interacts with the GUI to specify which of the features in the feature vector can be modified and a cost (or cost function for computing the cost) for each of a set of modifications. Features which cannot be modified or values that are not possible or acceptable to the user under any circumstances are given an infinite cost.

At S114, a modified feature vector 18 (classified by the model 12 in the desired first class) is identified, by the modification component 54, which uses a subset of the user-defined modifications, whose distance to the input feature vector results in the minimal total cost. The method then proceeds to S110. If no such feature vector can be found, the method may return to S112 to allow the user to modify the costs differently.

The method ends at S116.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 40, (for example, an internal hard drive of RAM), or may be separate (for example, an external hard drive operatively connected with the computer 40), or may be separate and accessed via a digital data network such as a local area network (LAN) or the Internet (for example, as a redundant array of inexpensive or independent disks (RAID) or other network server storage that is indirectly accessed by the computer 40, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 2, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Further details of the system and method will now be described.

In the case of binary classifiers 12, it can be assumed that the starting point is a trained classifier f and an initial feature vector v (v∈R^{|v|}), which is classified as class c or c′ (0 or 1): f(v)→{c, c′}, where c is considered a bad (second) class and c′ is a good (first) one. In some embodiments, |v|, the number of features in v, may be at least five or at least eight, or at least ten. At least two, or at least three, or all of the features may be modifiable by a user.

The aim is to modify v as little as possible in order to obtain v′ that is classified by the classifier as the opposite class c′=1−c. v′ can thus be described as the vector which minimizes a non-negative cost function d for changing from v to v′:

$${v}^{′} = {arg min}_{{v}^{′} \vert f ( {v}^{′} ) = {c}^{′}} d ( v , {v}^{′} ) \qquad ( 1 )$$

where the cost function d: R^{|v|}×R^{|v|}→R

In contrast to other approaches, the distance/cost function d is not restricted to being a norm. Rather, the aim is for it to be general, and may relax metric assumptions. To achieve this, d is defined component-wise, as the sum of the cost of changing from one feature value to another:

$$d ( v , {v}^{′} ) = {\sum }_{i = 0}^{\vert v \vert} {d}_{i} ( {v}_{i} , {v}_{i}^{′} ) \qquad ( 2 )$$

Each dᵢ(vᵢ,v′ᵢ) thus represents the cost of changing a respective initial feature value vᵢ in the initial feature vector to a modified feature value v′ᵢ in the modified feature vector, when the modified feature value differs from the initial feature value. This component-wise cost dᵢ is user-specific, and can be independently defined, as different users may value one attribute more than another. The costs dᵢ(vᵢ,v′ᵢ) may be defined through linear functions, or non-linear functions, e.g., exponential (e.g., quadratic), or stepwise functions, or combinations thereof, although the method is not limited to any specific type of function. In a linear function, the cost increases the same amount for each equal incremental change in the value (up or down). Different functions may be used for increasing values and decreasing values.

Each feature may have a set or range of possible feature values, which, in combination, define the multidimensional feature space of the classifier. For each or at least some, of the features, the user is permitted to assign a cost dᵢ for changing from the initial feature value to one or more of the other possible feature values or a function by which the cost for each changed feature value is computed. The cost for changing from a given feature value to another may be in a range of 0 to infinity. Changes that are assigned an infinite cost will not be changed in v′. All of the costs for the features are on the same scale, so that lower cost changes are more likely to be used in the minimal total cost function than higher cost changes, assuming that they result in a positive outcome.

Qualitative features may be encoded with one hot vectors. For example, in the case of gender, this may be a binary encoding with 1 corresponding to male and 0 corresponding to female. In the case of numerical features, such as income, a set of non-overlapping intervals may be defined as feature values, such as under 10, >10 to 20, >20 to 30, >30 to 40, and >40 thousand, which could be encoded as {1, 2, 3, 4}, or any other sort of alphanumeric encoding, which is associated in memory with the feature value it represents.

In one embodiment, the user may be provided with a table of possible modifications and asked to assign a cost to each. This is particularly useful where there is a small set of possible values for the feature.

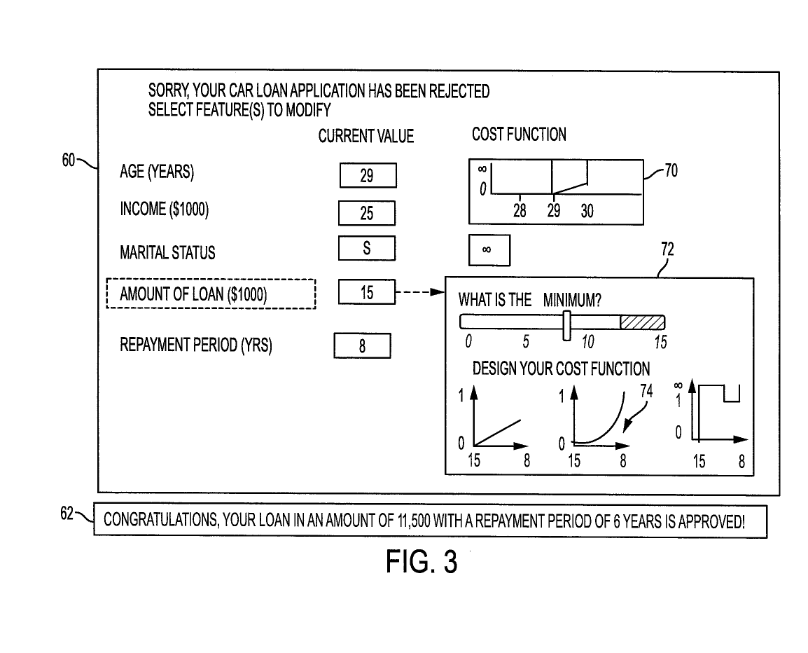

As an example, consider the case of a user applying for a car loan. The feature vector includes values for the following features (attributes): Age in years, Income in 1000's of dollars, Marital Status (1=married, 0=unmarried), Amount of loan in 1000's of dollars, and Repayment Period, in years. The user supplies the information for creating an initial feature vector: [29, 25, 0, 15, 8]. The classifier returns the decision that the loan application is rejected. As illustrated in FIG. 3, a GUI 60 may then be generated which asks the user for a cost (or cost function for computing the cost) for changing some or all of the initial feature values to other values. For the age feature, the user considers that she could wait, at most, a year for the loan and assigns a positive, non-infinite cost of changing from 29 to 30. In some embodiments, from the information she provides, a set of possible cost functions may be generated and may be illustrated to the user graphically or otherwise, as shown at 70. For the income and marital status, the user does not envisage a change and assigns an infinite cost to any change to these features. She has the opportunity to buy a cheaper car and, through interactions in a pop up box 72 on the GUI, chooses a function 74 which exponentially increases the cost for a reduction in the loan amount down to a minimum of 8,000. She also decides she would be able to pay the loan back in a shorter time, and chooses a cost function which increases the cost linearly down to a minimum of 5 years, and assigns a zero cost for increasing the repayment period up to 10 years. All other changes, other than those specified may be automatically assigned an infinite cost. As will be appreciated, for other users, the GUI 60 may be configured differently, depending on their level of understanding.

In one embodiment, the cost functions may be generated based on user answers to questions provided by the system, such as “how willing would you be to change the loan amount from 15,000 to 10,000 be?” (answer on a scale of 1 to 10 where 1 is very willing and 10 is not willing). Or the user may be free to select a different cost for each of a set of possible values of the feature. For example, if there are two cars available priced at 15 and 9 thousand, she could assign a cost of 0.1 to a change in the loan amount from 15 to 14, and the same from 14-13, a cost of 10 from 15 to 12, a cost of 2 for a change from 15-9, and so forth, depending on the value to her of the different loan amounts. In one embodiment, the GUI may identify the range of values for a given feature which are known to occur in one of the subspaces that are in the positive, first class, given the feature values which the user has already assigned. For example, if the user specifies that the income cannot be changed, the GUI may show the user that a loan of over $12,000 cannot be achieved without modifications to other features.

The modification component 54 then generates a modified feature vector by minimizes the total cost while resulting in a favorable loan decision. For example, it could generate a vector 18 [29, 25, 0, 11.5, 6] and present the information in the GUI in textual form as shown, for example, at 62.

### Algorithm for Tree-Ensembles (S102)

A method for identifying subspaces in which the vector 18 is assigned to the desired, first class is now described for classifiers learned with Tree-Ensembles (random forests). Random forest classifiers are very efficient non-linear classifiers which are widely used in a variety of applications. They operate by constructing a multitude of decision trees at training time and outputting the class that is the mode of the classes (classification) or mean prediction (regression) of the individual trees. Random forests correct for the decision trees' habit of overfitting to their training set.

It is assumed a random forest is composed of k binary decision trees, where k is at least 2, each tree being composed of a set of nodes, where at each node n, a single-feature threshold decision is made, dividing the remaining data-points into two sets, depending on whether feature x⁽ⁿ⁾ is a) smaller than or equal to, or b) larger than a threshold τₙ. Each leaf is associated with an outcome class(n), and each tree classifies an entry according to the leaf associated to the sequence of decisions in the path from the root. The ensemble method uses simple voting to determine the final prediction, each tree having one vote.

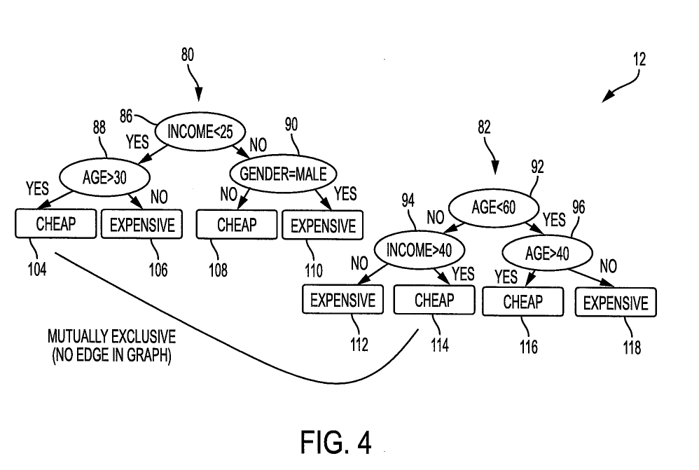

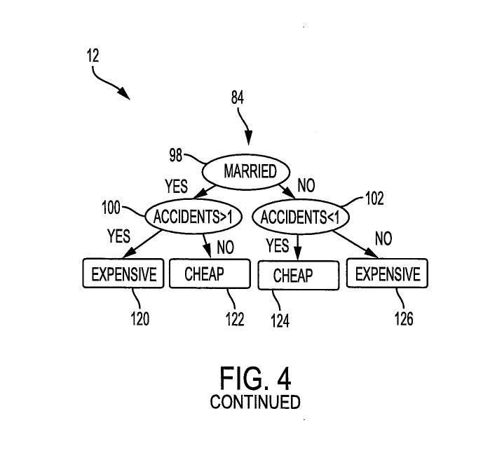

For example, FIG. 4 illustrates a simple random forest classifier 12 for providing insurance quotes. The classifier 12 includes three decision trees 80, 82, 84. Each tree includes a set of nodes 86, 88, 90, 92, 94, 96, 98, 100, 102, each having at most one parent node and two child nodes, or leaves. The trees terminate in leaves 104, 106, 108, 110, 112, 114, 116, 118, 120, 122, 124, 126, each corresponding to one of two classes, in this case “cheap” and “expensive.” However, since a given decision tree need not consider all the features, a leaf of a tree assigned to the positive (first) class does not guarantee that all vectors that would be assigned to that leaf are in the positive class. As can be seen, some of the outcomes on different trees are mutually exclusive, such as leaves 104 and 114, since leaf 104 requires the person to have an income less than 25 (thousand) and leaf 114 requires the person to have an income in excess of 40.

Construction of the Graph

To identify suitable subspaces, the leaf nodes of the first class c′ (leaves 104, 108, 114, 116, 122, and 124 in the FIG. 4 example) are represented as respective nodes of a graph 58. Edges are added to the graph if the sets they respectively restrict overlap (by definition, leaves of the same tree do not overlap). The subspace for which the ensemble classifier would then predict c′ is therefore defined by cliques of size

$$⌊ \frac{k}{2} ⌋ + 1 , where ⌊ \frac{k}{2} ⌋$$

represents the floor of

$$\frac{k}{2} ,$$

i.e., me iargest integer iess than or equal to

$$\frac{k}{2} .$$

A clique is a subset of vertices of the undirected graph 58 such that its induced subgraph is complete, i.e., every vertex of that subgraph is connected to all other of that subgraph.

An undirected graph G=(V,E), is constructed, with V denoting the set of vertices (nodes) and E the set of pairs of nodes denoting edges. Each leaf node i of class c′ of decision tree j will correspond to a node (vertex) in the graph G, where:

V={nᵢ^{(j)}|1≤j≤k,class(nᵢ^{(j)})=c′,nᵢ^{(j)} is a leaf node of tⱼ} (3)

Then a pair of leaf nodes (nᵢ_{₁}^{(j}^{₁}⁾,nᵢ_{₂}^{(j}^{₂}⁾) from two trees t₁ and t₂ will have an edge in E, if the following conditions hold:

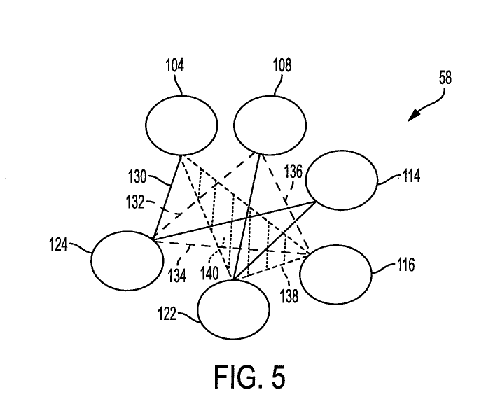

1. The intersection of their corresponding intervals is non-empty (which, in particular, implies that j₁≠j₂, i.e., the nodes are not from the same tree). As an example, in the classifier of FIG. 4, nodes 104 and 114 are incompatible since they would require an income less than 25,000 and greater than 40,000, and thus are mutually exclusive. No edge is therefore created between these nodes in the graph of FIG. 5.

2. They denote a consistent solution: A consistent solution refers to potential global constraints due to the representation of qualitative attributes in the feature space. For example, a person's gender may be encoded as a one-hot binary vector, but an interval which forces both to be 0 is not consistent (given a one-hot encoding of length m, of the m interval restrictions at least one has to admit a 1 and m−1 has to admit a 0).

With this graph, any clique of size at least

$$⌊ \frac{k}{2} ⌋ + 1$$

now corresponds to a (possibly empty) space where the random forest would predict class c′ as outcome. The method includes enumerating those cliques, filtering out empty and inconsistent ones, and, in step S114, measuring their distance d to the original feature vector v, using equations (1) and (2).

As an example, FIG. 5 shows the graph 58 generated for the classifier 12 shown in FIG. 4, with permissible edges 130, 132, 134, etc. denoted by lines connecting the leaf nodes 104, 108, etc., that are in the desired, first class. Since k=3,

$$⌊ \frac{k}{2} ⌋ + 1 = ⌊ \frac{3}{2} ⌋ + 1 = 1 + 1 = 2.$$

Thus, the minimum size of a clique is 2. Two different cliques 136, 138 of size 3 are illustrated by way of example, although other and larger sized cliques can be observed in the graph.

Most problems involving cliques are NP-hard, and thus rapidly increase in complexity, and finding k-cliques is no exception, even more so enumerating them (see, Garey, et al., “Computers and intractability: A Guide to the Theory of NP-Completeness,” W.H. Freeman and Company, New York, 1979). Enumerating cliques is known to be polynomial in the output (which can be exponential), and with time delay (the time between two consecutive outputs) of O(|E∥V|) (Tsukiyama, et al., “A new algorithm for generating all the maximal independent sets,” SIAM Journal on Computing, 6(3), 505-517, 1977). However, efficient algorithms exist that are fast enough to provide enough samples of cliques in order to be of reasonable use in practice. See, for example, Ryan Rossi, “Parallel Maximum Clique Library,” 2013, available at https://github.com/ryanrossi/pmc. While not necessarily enumerating all possible solutions, such methods are shown in the examples below to provide beneficial results in terms of modifying the input feature vector to generate the desired outcome.

For each clique, the intersection of all its corresponding vertices is found. For example, for clique 138, this corresponds to the shaded area 140 on FIG. 5. The shortest path between the initial vector 16 and that subspace 140 is computed. Cliques can be progressively enumerated and the clique(s) with the shortest path stored in memory, discarding the others. The clique with the shortest path, i.e., lowest d(v,v′), is retained. The algorithm can be set to enumerate a fixed number of cliques or to stop at some other stopping point.

For linear, SVM or neural network-based classifiers, existing solutions, such as those described in Biggio 2013, can be applied.

The application of Eq. (1) in a system where the goal is to help the user (or the intermediate human agent) find better solution differs from existing methods. Adversarial learning has different objectives, which are more often than not reflected in the choice of methods used. The data is assumed to be non-stationary, so that the adversary can cherry-pick data-points, which leads to an arms-race with malicious intent (spam, malware, network intrusion, etc.). Here, the component is applied in a system where the goal is beneficial to the user and the provider, in order to help guide the user to find the least expensive way for a positive outcome. Previous approaches to find adversarial examples (such as those of Biggio 2013) can also be adapted to this new scenario.

The reduction to a clique problem is useful to address the case of a random forest where the cost function can be arbitrary. The algorithm is optimal, in the sense that it will find the exact solution if it keeps running. However, the incremental nature of the algorithm permits partial solutions to be shown as soon as they are found, and in the examples below, they were found to be quickly good enough. In particular, the cliques may be identified and/or evaluated one by one, computing the distance (cost) from the subspace defined by the clique to the input vector 16. Each time a new clique is identified that has a lower distance (cost) it is stored in memory. The system may output the lowest cost solution (smallest distance), or may output a set of solutions which are below a given threshold.

The system and method find application in a variety of situations including insurance (e.g., binary classes corresponding increased cost and decreased cost), loan or credit applications (e.g., loan granted and loan not granted), college acceptance (accepted and not accepted), among others.

Without intending to limit the scope of the exemplary embodiment, the following examples illustrate the application of the method.

### Examples

The algorithm described above was implemented and tested on the German Credit Data from UCI see, Lichman, “UCI Machine Learning Repository” http://archive.ics.uci.edu/ml, Irvine, Calif.: University of California, School of Information and Computer Science, 2013. Each qualitative attribute (13 out of 20) was encoded as a one-hot vector, while the other 7 numerical attributes were used in their original form. These features include gender, credit history, savings, employment status, and others. This is a binary classification problem, where each feature vector is labeled as good or bad. A random forest classifier 12 (using 10 decision trees) was employed. The classifier achieves an accuracy of 74.6% on 3-fold cross-validation, which is in line with what is reported in the literature (Ratanamahatana, et al., “Scaling up the Naive Bayesian Classifier: Using Decision Trees for Feature Selection,” Citeseer, pp. 1-10, 2002, O'Dea, et al., “Combining feature selection and neural networks for solving classification problems,” Proc. 12th Irish Conf. Artificial Intell. Cognitive Sci., pp. 157-166, 2001). It had similar performance to other classifiers investigated (outperforming nearest-neighbor, Naive Bayes with various priors, and SVM with various kernels; while logistic regression obtained better performance).

For the clique finder, the Parallel Maximum Clique (PMC) Library (Rossi, et al., “A fast parallel maximum clique algorithm for large sparse graphs and temporal strong components,” ArXiv:1302.6256, 2013; https://github.com/ryanrossi/pmc), which proved to be very fast.

User-specific weights: The user can specify any possible weights (costs). For this data-set, a parser was generated which allows for numerical attributes to say how much a single unit modification costs (differentiating up and down), allowing for a linear weight. For qualitative attributes the user can give the cost from any attribute to any other.

The random forest classifier is created (and checked to be sure that it provides reasonable accuracy) with the following code:

from sklearn.cross_validation import train_test_split
from sklearn.ensemble import RandomForestClassifier
X_train, X_test, y_train, y_test = train_test_split(X,Y)
clf = RandomForestClassifier( )
clf.fit(X_train,y_train)
print ‘Test accuracy: %f’%(clf.score(X_test,y_test))
Test accuracy: 0.760000

The graph is created with the following code, creating a node for each leaf of class 1 (the desired). This can take some time, since it is quadratic in the number of leaves:

print ‘Total number of leaves: %d’%sum(sum(t.tree_.children_left ==
−1) for t in clf.estimators_)
Total number of leaves: 1859
import utils
G = utils.Graph(clf,T,targetClass=1,cmdpath=‘./pmc-master/pmc’)
(cmdpath is the path to the executable of Parallel Maximum Clique
library, which is used later to find cliques. It will read the graph from a
file, e.g., stored on a disk.)
graphpath.‘graph.mtx’
G.edges2MM(graphpath)
k=int(len(clf.estimators_)/2) + 1
shortest = float(‘inf’)
cliques=G.getCliques(k)

The data-structure creation step has to be done only once, as the target class should in generally be the same.

The attributes considered are shown in TABLE 1.

TABLE 1
Attribute Information

| Attribute | Feature values |
|---|---|
| 1: (qualitative): Status | A11: . . . <0 DM |
| of existing checking | A12: 0 ≤ . . . < 200 DM |
| account | A13: . . . ≥200 DM/salary assignments for at least 1 year |
| | A14: no checking account |
| 2: (numerical): | Duration in months |
| 3: (qualitative) Credit | A30: no credits taken/all credits paid back duly |
| history | A31: all credits at this bank paid back duly |
| | A32: existing credits paid back duly until now |
| | A33: delay in paying off in the past |
| | A34: critical account/other credits existing (not at this bank) |
| 4: (qualitative): | A40: car (new) |
| Purpose | A41: car (used) |
| | A42: furniture/equipment |
| | A43: radio/television |
| | A44: domestic appliances |
| | A45: repairs |
| | A46: education |
| | A47: vacation |
| | A48: retraining |
| | A49: business |
| | A410: others |
| 5: (numerical) | Credit amount |
| 6: (qualitative) | A61: . . . <100 DM |
| Savings | A62: 100 ≤ . . . < 500 DM |
| account/bonds | A63: 500 ≤ . . . < 1000 DM |
| | A64: .. ≥1000 DM |
| | A65: unknown/no savings account |
| 7: (qualitative) | A71: unemployed |
| Present employment | A72: . . . <1 year |
| since | A73: 1 ≤ . . . < 4 years |
| | A74: 4 ≤ . . . < 7 years |
| | A75: .. ≥7 years |
| 8: (numerical) | Installment rate in percentage of disposable income |
| 9: (qualitative) | A91: male: divorced/separated |
| Personal status and | A92: female: divorced/separated/married |
| gender | A93: male: single |
| | A94: male: married/widowed |
| | A95: female: single |
| 10: (qualitative) Other | A101: none |
| debtors/guarantors | A102: co-applicant |
| | A103: guarantor |
| 11: (numerical) | Present residence since |
| 12: (qualitative) | A121: real estate |
| Property | A122: if not A121: building society savings agreement/life |
| | insurance |
| | A123: if not A121/A122: car or other, not in attribute 6 |
| | A124: unknown/no property |
| 13: (numerical) | Age in years |
| 14: (qualitative) Other | A141: bank |
| installment plans | A142: stores |
| | A143: none |
| 15: (qualitative) | A151: rent |
| Housing | A152: own |
| | A153: for free |
| 16: (numerical) | Number of existing credits at this bank |
| 17: (qualitative) Job | A171: unemployed/unskilled - non-resident |
| | A172: unskilled - resident |
| | A173: skilled employee/official |
| | A174: management/self-employed/ |
| | highly qualified employee/officer |
| 18: (numerical) | Number of people liable to provide maintenance for |
| 19: (qualitative) | A191: none |
| Telephone | A192: yes, registered under the customer's name |
| 20: (qualitative) | A201: yes |
| foreign worker | A202: no |

A new attribute vector for somebody applying for a credit was generated to test the system. The following is a credit application for 100000 DM (Deutsche Mark), for a duration of 72 months to buy a new car; submitted by a 64 year-old, male, single, unskilled resident.

attributes =
[‘A12’,72,‘A33’,‘A40’,100000,‘A61’,‘A71’,2,‘A94’,‘A102’,3,
‘A124’,64,‘A141’,‘A151’,5,‘A172’,3,‘A192’,‘A202’,3]
features = T.transformRow(attributes)[0]

This example is constructed such that the rating would be bad (class 2):

print clf.predict([features])[0]
2

Table 2 provides an example of some of the features weights (costs), which can be varied by the user. Inf. indicates an infinite weight. For qualitative features, the user enters a cost to change from one feature to another.

TABLE 2
Example User-generated weights

weightPath=“./values.config”
with open(weightPath) as f:
print f.read( )
T.loadWeights(weightPath)

| Feature Type | Cost of modification |
|---|---|
| Qualitative | A1 # checking account |
| | A14 * 0.1 |
| | A13 A11 0.1 |
| | A13 A12 0.1 |
| | A12 A11 0.1 |
| | A13 A12 50 |
| | A12 A13 50 |
| | A13 A11 100 |
| | A12 A14 150 |
| | A3 #credit history |
| | A30 * 0.1 |
| | A32 * 0.1 |
| | A33 * inf |
| | A31 A30 100 |
| | A31 A32 0.1 |
| | A31 A33 0.1 |
| | A31 A34 0.1 |
| | A32 A31 100 |
| | A32 A31 200 |
| | A34 * inf |
| | A4 # purpose |
| | A40 * inf |
| | A41 * inf |
| | A42 * inf |
| | A43 * inf |
| | A44 * inf |
| | A45 * inf |
| | A46 * inf |
| | A47 * inf |
| | A48 * inf |
| | A49 * inf |
| | A410 * inf |
| | A9 # personal status |
| | # male->female is not under consideration |
| | A91 A92 inf |
| | A91 A95 inf |
| | A93 A92 inf |
| | A93 A95 inf |
| | A94 A91 inf |
| | A94 A95 inf |
| | A94 A92 inf |
| | # female->male is not under consideration |
| | A92 A91 inf |
| | A95 A91 inf |
| | A91 A93 inf |
| | A95 A93 inf |
| | A91 A94 inf |
| | A95 A94 inf |
| | #once separated, always |
| | A91 A93 inf |
| | A92 A95 inf |
| | A94 A93 inf |
| | # hard to get married |
| | A93 A94 500 |
| | A93 A91 550 |
| | A94 A91 200 |
| | A95 A92 200 |
| Numerical | A2 #duration, months |
| first # is go up, | 0.1 10 |
| second is go | A5 #amount, DMs |
| down | 0.1 0.3 |
| | A8 #installment rate in percentage of disposable income |
| | 0.1 50 |
| | A11 #present residence, years |
| | 200 0.1 |
| | A13 #age, years |
| | 200 inf |
| | A16 #existing credits at this bank |
| | 0.1 50 |

For each clique, the intersection of all its corresponding vertices is found and the shortest path between the target (input) vector and that interval is computed. Every time a better solution (cheaper) is found, the changes to be done are enumerated. The implementing code, followed by a sequence of modifications, is shown in TABLE 3.

TABLE 3
Identifying a Modified Vector

k=len(clf.estimators_)/2 + 1
cliques=G.getCliques(k)
shortest = float(‘inf’)
while shortest > 300.: #put any value you want
ac = cliques.next( )
aChance = utils.intersectAll([G.vertices[i][0] for i in ac])
if not utils.consistent(aChance,T):
continue
cost = germanCreditData.findShortestDistance(T,aChance,features)
if cost < shortest:
print ‘Total cost: %of’%cost
T.explainChange(features,aChance.values( ))
print
shortest = cost
Total cost: 30478.900000
Duration in month: go from 72.000000 to 34.500000
Credit amount: go from 100000.000000 to 5237.500000
Installment rate in percentage of disposable income: go from
2.000000 to 2.500000
Number of existing credits at this bank: go from 5.000000 to
1.500000
From “Other installment plans: bank” (A141) to “Other installment
plans: none (A143) (cost: 500.000000)”
From “Job: unskilled - resident” (A172) to “Job: skilled employee/
official (A173) (cost: 1000.000000)”
From “foreign worker: no” (A202) to “foreign worker: yes (A201)
(cost: 0.100000)”
Total cost: 30478.850000
Duration in month: go from 72.000000 to 34.500000
Credit amount: go from 100000.000000 to 5237.500000
Number of existing credits at this bank: go from 5.000000 to
1.500000
From “Other installment plans: bank” (A141) to “Other installment
plans: none (A143) (cost: 500.000000)”
From “Job: unskilled - resident” (A172) to “Job: skilled employee/
official (A173) (cost: 1000.000000)”
From “foreign worker: no” (A202) to “foreign worker: yes (A201)
(cost: 0.100000)”
Total cost: 30478.800000
Duration in month: go from 72.000000 to 34.500000
Credit amount: go from 100000.000000 to 5237.500000
Installment rate in percentage of disposable income: go from
2.000000 to 2.500000
Number of existing credits at this bank: go from 5.000000 to
1.500000
From “Other installment plans: bank” (A141) to “Other installment
plans: none (A143) (cost: 500.000000)”
From “Job: unskilled - resident” (A172) to “Job: skilled employee/
official (A173) (cost: 1000.000000)”
Total cost: 29978.900000
Duration in month: go from 72.000000 to 34.500000
Credit amount: go from 100000.000000 to 5237.500000
Installment rate in percentage of disposable income: go from
2.000000 to 2.500000
Number of existing credits at this bank: go from 5.000000 to
1.500000
From “Other installment plans: bank” (A141) to “Other installment
plans: none (A143) (cost: 500.000000)”
From “Job: unskilled - resident” (A172) to “Job: management/self-
employed/(A174) (cost: 500.000000)”
From “foreign worker: no” (A202) to “foreign worker: yes (A201)
(cost: 0.100000)”
Total cost: 505.150000
Installment rate in percentage of disposable income: go from
2.000000 to 2.500000
From “Other installment plans: bank” (A141) to “Other installment
plans: none (A143) (cost: 500.000000)”
From “Job: unskilled - resident” (A172) to “Job: unemployed/
unskilled - non-resident (A171) (cost: 5.000000)”
From “foreign worker: no” (A202) to “foreign worker: yes (A201)
(cost: 0.100000)”
Total cost: 430.150000
Duration in month: go from 72.000000 to 29.000000
Installment rate in percentage of disposable income: go from
2.000000 to 2.000000
Present residence since: go from 3.000000 to 1.500000
Total cost: 302.250000
Installment rate in percentage of disposable income: go from
2.000000 to 3.500000
Age in years: go from 64.000000 to 65.500000
From “Status of existing checking account: 0 <= ... < 200 DM”
(A12) to “Status of existing checking account: ... <0 DM (A11)
(cost: 0.100000)”
From “Telephone: yes, registered under the customer's name” (A192)
to “Telephone: none (A191) (cost: 2.000000)”
Total cost: 130.000000
Number of existing credits at this bank: go from 5.000000 to
2.500000
From “Job: unskilled - resident” (A172) to “Job: unemployed/
unskilled - non-resident (A171) (cost: 5.000000)”

As can be seen from this example, the enumeration of cliques results in a low cost solution. The user may be presented with the lowest cost solution identified, or a set of the lowest cost solutions.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for guiding users in an automated decision-making environment, comprising:
receiving an initial feature vector which is classified with a classifier model, the classification being a second of a plurality of classes;
providing for a user to define costs for independently modifying feature values for at least some features in the initial feature vector;
identifying subspaces in a feature space in which the classifier model classifies an input feature vector in a first of the set of classes; and
with a cost function which takes into account the user-defined costs, identifying a modified feature vector in one of the identified subspaces which optimizes the cost function; and
outputting the modified feature vector or information based thereon,
wherein at least one of the identifying subspaces and identifying a modified feature vector is performed with a processor.

2. The method of claim 1, wherein the cost function computes a sum of user-defined costs of modification for each of the modified feature values in the modified feature vector.

3. The method of claim 1, wherein the cost function is of the form:
$$d ( v , {v}^{′} ) = {\sum }_{i = 0}^{\vert v \vert} {d}_{i} ( {v}_{i} , {v}_{i}^{′} )$$
where d(v, v′) represents the total cost of changing the initial vector v to the modified vector v′, and
each dᵢ(vᵢ,v′ᵢ) represents the cost of changing a respective feature value vᵢ in the initial feature vector to feature value v′ᵢ in the modified feature vector.

4. The method of claim 1, wherein the classifier model is a binary classifier.

5. The method of claim 1, wherein the classifier model is a random forest classifier comprising a plurality of decision trees.

6. The method of claim 5, wherein the identifying subspaces in a feature space comprises generating a graph in which nodes of the graph represent leaves of the decision trees that include vectors which are assigned to the first class, and wherein edges connect nodes that are not mutually exclusive, and identifying cliques of nodes connected by edges, each clique defining intervals of values for each the features defining one of the subspaces.

7. The method of claim 6, wherein each of the cliques includes at least
$$⌊ \frac{k}{2} ⌋ + 1$$
nodes, where k is the number of decision trees.

8. The method of claim 6, wherein a pair of leaf nodes (nᵢ_{₁}^{(j}^{₁}⁾,nᵢ_{₂}^{(j}^{₂}⁾) from trees t₁ and t₂ have an edge in E, if the following conditions hold:
i. the intersection of their corresponding intervals is non-empty; and
ii. they denote a consistent solution.

9. The method of claim 1, wherein the first of the set of classes corresponds to a desirable decision for the user and the second of the set of classes corresponds to an undesirable decision for the user.

10. The method of claim 1, wherein some of the features correspond to qualitative attributes of the user and some of the features correspond to numerical attributes of the user.

11. The method of claim 1, wherein the providing for the user to define costs comprises displaying a graphical user interlace which enables the user to select costs for changing from one value of one of the features to another value of that feature.

12. The method of claim 1, wherein the providing for the user to define costs comprises providing for the user to assign an infinite cost to a first of the feature values in the initial feature vector that is not to be modified and a non-infinite cost to at least one feature values of a second of the features that is permitted to be modified.

13. The method of claim 1, further comprising receiving the user-define costs for independently modifying feature values for at least some features in the initial feature vector.

14. The method of claim 1, wherein the output information includes a textual representation of at least some of the feature values in the modified feature vector.

15. The method of claim 1, wherein the user is permitted to define costs for a sequence of feature values for a given feature that increase or decrease non-linearly.

16. The method of claim 1, wherein the feature vectors each include at least five features.

17. A computer program product comprising a non-transitory recording medium storing instructions, which when executed on a computer, causes the computer to perform the method of claim 1.

18. A system comprising memory which stores instructions for performing the method of claim 1, and a processor in communication with the memory which executes the instructions.

19. A system for guiding users in an automated decision-making environment, comprising:
a classifier component which classifies a feature vector with a classifier model and outputs a classification for an input feature vector;
a graphical user interface generator which provides for a user to define costs for modifying feature values for at least some of the features in a feature vector for which the classification is a second of a set of classes;
a mapping component which identifies subspaces in a feature space in which the classifier model classifies an input feature vector in a first of the set of classes; and
a modification component which identifies a modified feature vector in one of the identified subspaces which optimizes a cost function with a subset of the user defined costs; and
an output component which outputs the modified feature vector or information based thereon; and
a processor which implements the classifier component, graphical user interlace generator, mapping component, modification component, and output component.

20. A method for guiding users in an automated decision-making environment, comprising:
identifying leaves of decision trees of a random forest classifier model which are associated with a first of a plurality of classes;
generating a graph in which nodes represent the identified leaves, including connecting pairs of nodes which represent leaves that are not inconsistent with edges;
identifying cliques in the graph of size at least
$$⌊ \frac{k}{2} ⌋ + 1$$
nodes, where k is the number of decision trees, each clique corresponding to a subspace in which a feature vector is classified by the classifier model in the first of the plurality of classes;
providing for a user to define costs for modifying feature values of at least some of the features in an initial feature vector which is classified by the classifier model in a second of the plurality of classes;
with a cost function which takes into account the user-defined costs, identifying a modified feature vector in one of the identified subspaces which optimizes the cost function; and
outputting the modified feature vector or information based thereon,
wherein at least one of the identifying leaves, identifying cliques and identifying a modified feature vector is performed with a processor.
